(19) United States
(12) Patent Application Publication
(10) Pub. No.: US 2026/0110591 A1
(43) Pub. Date: Apr. 23, 2026

(54) PREDICTION METHOD FOR RESIDUAL STRENGTH OF ANCIENT WOOD APPLIED IN SHAKING TABLE TEST OF WOOD STRUCTURE OF ANCIENT BUILDING

(71) Applicant: Tianjin University, Tianjin (CN)

(72) Inventors: Lichen Wang, Tianjin (CN); Ke Zhang, Tianjin (CN); Qinghua Han, Tianjin (CN)

(21) Appl. No.: 18/977,800

(22) Filed: Dec. 11, 2024

(30) Foreign Application Priority Data
Oct. 18, 2024 (CN) 202411457293.6

(51) Int. Cl. G01M 7/02

(52) U.S. Cl. CPC G01M 7/025

(57) ABSTRACT

The present disclosure provides a prediction method for residual strength of ancient wood applied in a shaking table test of a wood structure of an ancient building, falling within the technical field of ancient wood testing. The method includes the following steps. In Si, a wood type and an origin to be predicted are determined. In S2, new wood of the same type and origin are selected to process test pieces according to determined wood type and origin. In S3, a test of duration of load effect of wood is carried out on processed test pieces. The test of duration of load effect of wood includes a test of bending duration of load effect of wood along the grain and a test of compressive duration of load effect of wood along the grain. The present disclosure can improve the universality and accuracy of prediction of ancient wood residual strength.

### CROSS-REFERENCE TO RELATED APPLICATION

This application claims priority of Chinese Patent Application No. 202411457293.6, filed on Oct. 18, 2024, the entire contents of which are incorporated herein by reference.

### TECHNICAL FIELD

The present disclosure belongs to the technical field of ancient wood testing, and particularly relates to a prediction method for residual strength of ancient wood applied in a shaking table test of a wood structure of an ancient building.

### BACKGROUND

Ancient buildings constitute the most significant portion of China's numerous tangible cultural heritage sites, possessing invaluable historical, artistic, and scientific research value. Meanwhile, as carriers of ancient cultural traditions, their importance is self-evident. China is prone to earthquakes characterized by high frequency, intensity, shallow epicenters, and widespread distribution. Earthquake effects can cause varying degrees of damage to ancient wooden buildings, such as loosening of mortise and tenon joints, structural inclination, and even complete collapse. Therefore, it is an urgent and critical task to explore the failure mechanisms of ancient buildings under earthquake actions and subsequently reinforce and protect them. Shaking table tests for the ancient wooden buildings are currently the most widely used intuitive research method. Conducting the shaking table tests for the ancient wooden buildings first requires the fabrication of test models. However, wood used in ancient buildings differs from new wood; the wood in ancient buildings has been utilized as structural components for hundreds or even thousands of years. Due to the influence of long-term sustained loads, the wood undergoes varying degrees of creep and cumulative damage, leading to material property degradation. Therefore, it is necessary to predict the residual strength of wood used in ancient wooden buildings under long-term loads through reasonable methods to ensure consistency between the shaking table test models of ancient wooden buildings and the original ancient wooden buildings, enhancing the accuracy of test results.

The core of a prediction method for residual strength of ancient wood of shaking table test of a wood structure of an ancient building is to clarify duration of load effect of wood. The Duration of load (DOL effect) refers to the phenomenon that the deformation of wood gradually increases and the strength gradually decreases with the increase of load duration. In view of this DOL effect, some researches have been carried out at home and abroad, mainly including wood DOL test and theoretical prediction model based on the test.

However, at present, the systematic research goal of wood DOL effect at home and abroad mostly focuses on predicting the service life of wood structures, and few studies focus on directly obtaining the residual strength of ancient wood buildings after long-term load deterioration. Meanwhile, the prediction of residual strength for the deterioration of ancient buildings in China is often based on the cumulative damage model of wood proposed by American scholar Gerhards. However, the cumulative damage model of wood is calibrated based on the ten-year long-term test data of commonly used wood abroad. The prior research shows that the material properties of wood may be affected by the difference of wood types and growth environment, the direct use of the parameters in the cumulative damage model provided by foreign scholars cannot well reflect the DOL effect characteristics of wood used in ancient buildings in China, and the lack of accurate parameters based on the long-term test data of wood used in ancient buildings in China may cause certain prediction errors.

### SUMMARY

The present disclosure aims at solving at least one of the technical problems in the above related technologies to some extent.

An object of the present disclosure is to provide a prediction method for residual strength of ancient wood applied in a shaking table test of a wood structure of an ancient building, which can improve the universality and accuracy of prediction of ancient wood residual strength.

In order to solve the above technical problems, the present disclosure is realized as follows.

An embodiment of the present disclosure provides a prediction method for residual strength of ancient wood applied in a shaking table test of a wood structure of an ancient building, including the following steps:
S1, determining a wood type and an origin predicted by residual strength of ancient wood according to a test target object;
S2, selecting new wood of the same type and origin to process test pieces according to determined wood type and origin;
S3, carrying out a test of duration of load effect of wood on processed test pieces, where the test of duration of load effect of wood includes a test of bending duration of load effect of wood along the grain and a test of compressive duration of load effect of wood along the grain;
S4, calibrating model parameters in a wood cumulative damage model according to the results of a test of duration of load effect of wood; and
S5. obtaining a residual strength prediction formula of the ancient wood through derivation and solution, and predicting the residual strength of the ancient wood according to a wood cumulative damage model with calibrated parameters.

In addition, the prediction method for residual strength of ancient wood applied in a shaking table test of a wood structure of an ancient building according to the present disclosure can also have the following additional technical features.

In some embodiments, the test of bending duration of load effect of wood along the grain includes three sub-tests, namely, a bending elastic modulus test, a short-term bending strength test and a long-term bending life test.

In some embodiments, the test of compressive duration of load effect of wood along the grain includes three sub-tests, namely, a test piece density measurement test, a short-term compressive strength test and a long-term compressive life test.

In some embodiments, there are not less than 30 test pieces in each sub-test to reduce the discreteness of data results.

In some embodiments, the bending elastic modulus test is carried out by means of four-point bending chord-wise loading, and displacement control loading is carried out at a specific rate; during a loading process, relative longitudinal displacement at a midspan and a bearing of the test pieces is measured to obtain a load-displacement curve, and the bending elastic modulus of the test pieces is calculated by taking data at specific points.

In some embodiments, the test pieces are divided into two groups according to the results of the bending elastic modulus test, and a principle of grouping is that distribution laws of two groups of elastic modulus are consistent; and in two groups of the test pieces, one for the short-term bending strength test and the other for the long-term bending life test.

In some embodiments, the short-term bending strength test adopts a three-point bending chord-wise loading mode, and the displacement control loading is carried out at a specific rate until the test pieces are destroyed, and short-term bending strength of the test pieces are calculated by taking a load when the test pieces are destroyed as the maximum load.

In some embodiments, in the long-term bending life test, the three-point bending chord-wise loading mode is adopted, and trapezoidal cyclic loading is carried out by a load control method until the test pieces are destroyed, and a number of cycles experienced when the test pieces are destroyed is recorded; and each trapezoidal cycle process includes three processes: loading, holding and unloading, and each process is linear loading and lasts for a fixed time.

In some embodiments, a plurality of the test pieces is subjected to density measurement tests, and the test pieces are divided into two groups according to the results of the density measurement tests, with a principle that density distribution laws of the two groups are consistent; and among the two groups of the test pieces, one group is used as test pieces of the short-term compressive strength test and the other group as test pieces of the long-term compressive life test.

In some embodiments, the short-term compressive strength test adopts a longitudinal loading mode along the grain, and the displacement control loading is carried out at a specific rate until the test pieces are destroyed, and a load when the test pieces are destroyed is recorded as the maximum load, and the short-term compressive strength of the test pieces is calculated.

In some embodiments, in the long-term compressive life test, the trapezoidal cyclic loading is carried out along the grain direction of the test pieces by the load control method until the test pieces are destroyed, and the number of cycles carried out when the test pieces are destroyed is recorded; each trapezoidal cycle process includes three processes: loading, holding and unloading, and each process is linear loading and lasts for a fixed time.

In some embodiments, the content of S4 includes respectively corresponding distribution data of short-term bending/compressive strength obtained from the test of duration of load effect of wood with the distribution law of long-term bending/compressive failure cycles one by one, and obtaining the corresponding life of each test piece under the bending/compressive load strength it bears by means of equipartition value matching as the results of the test of duration of load effect of wood.

Compared with the prior art, the present disclosure has at least the following beneficial effects.

In the embodiments of the present disclosure, the prediction method for residual strength of ancient wood applied in a shaking table test of a wood structure of an ancient building can be used for carrying out corresponding test of duration of load effect of wood test to correct model parameters according to different wood types of different ancient buildings in China, and has strong applicability for different wood types. According to different wood load forms (such as bending along the grain and compression along the grain), the corresponding test of duration of load effect of wood can be carried out to correct the model parameters, which has strong applicability for different wood load forms.

In the embodiments of the present disclosure, the prediction method for residual strength of ancient wood applied in a shaking table test of a wood structure of an ancient building innovatively adds a process of the test of duration of load effect of wood, and calibrates relevant prediction parameters according to the test results, obtaining a prediction method for the residual strength of the ancient wood which is more suitable for ancient buildings in China.

In the embodiments of the present disclosure, the prediction method for residual strength of ancient wood applied in a shaking table test of a wood structure of an ancient building innovatively adopts a trapezoidal cyclic loading method to load small samples of wood to obtain long-term life of the test pieces in long-term bending/compressive life tests, and on this basis, relevant parameters reflecting the duration of load effect of wood can be obtained according to the data.

Additional aspects and advantages of the present embodiments will be set forth in part in the description which follows, and in part will be obvious from the description which follows, or may be learned by practice of the present disclosure.

### BRIEF DESCRIPTION OF THE DRAWINGS

FIG. 1 is a flow chart of a prediction method for residual strength of ancient wood applied in a shaking table test of a wood structure of an ancient building according to an embodiment of the present disclosure;

FIG. 2 is a logical relationship diagram of a test of bending duration of load effect of wood along the grain according to an embodiment of the present disclosure;

FIG. 3 is a schematic diagram (unit: mm) of a test piece of a test of bending duration of load effect of wood along the grain according to an embodiment of the present disclosure;

FIG. 4 is a load-time graph of a long-term bending test according to an embodiment of the present disclosure;

FIG. 5 is a logical relationship diagram of a test of compressive duration of load effect of wood along the grain according to an embodiment of the present disclosure;

FIG. 6 is a schematic diagram (unit: mm) of a test piece of the test of compressive duration of load effect of wood along the grain according to an embodiment of the present disclosure; and

FIG. 7 is a load-time graph of a long-term compressive test according to an embodiment of the present disclosure.

### DETAILED DESCRIPTION

In the following, the technical scheme in the embodiment of the present disclosure will be clearly and completely described with reference to the attached drawings. Obviously, the described embodiments are parts of the embodiments of the present disclosure, but not the whole embodiments. Based on the embodiments in the present disclosure, all other embodiments obtained by ordinary technicians in the field without creative labor fall within the scope of protection of the present disclosure.

The embodiments of the present disclosure will be described in detail through specific embodiments and application scenarios with reference to the attached drawings.

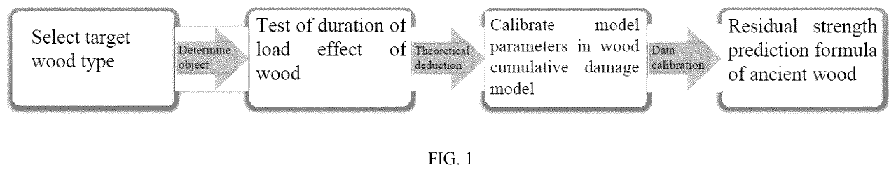

Referring to FIG. 1, in some embodiments of the present disclosure, a prediction method for residual strength of ancient wood applied in a shaking table test of a wood structure of an ancient building is provided, which mainly includes the following four steps.

In step 1, a wood type for predicting the residual strength of the ancient wood is determined according to the wood used by a target object of a shaking table test of an ancient building. For example, an object of the shaking table test of the ancient building is Yingxian wooden tower, and the wood type of residual strength prediction of the ancient wood is determined as Larix principis-rupprechtii used in the Yingxian wooden tower;

In step 2, a test of duration of load effect of wood is carried out on a new type of the wood type (such as Larix principis-rupprechtii).

In step 3, model parameters in a wood cumulative damage model are calibrated according to the results of the test of duration of load effect of wood

In step 4, based on a cumulative damage model of updated parameters, a residual strength prediction formula of the ancient wood is deduced theoretically.

A flow of the technical solution of the present disclosure is shown in FIG. 1, and the specific implementation of each step is explained in detail below.

In step 1, the wood type for predicting the residual strength of the ancient wood is determined according to the wood used by the target object of the shaking table test of the ancient building, which is capable of adopting the methods such as literature investigation and statistics and old wood types identification. For example, literature research is capable of determining types and origins of wood used in construction of the ancient building according to historical records, and old wood types identification is capable of obtaining wood test pieces from a target ancient building for inspection by third-party institutions to determine types and origins of wood used in the construction.

In step 2, according to the wood types and origins obtained in the above step, the wood with same types and origins are selected to be processed and carry out the test of duration of load effect of wood. Because wood is an anisotropic material, the duration of load effect of wood is related to the load forms. The test of duration of load effect of wood is capable of being divided into two types: a test of bending duration of load effect of wood along the grain and a test of compressive duration of load effect of wood along the grain. Both types of the test of duration of load effect include three sub tests, each of which uses several test pieces to reduce the dispersion of data results, and each sub test has a clear logical relationship.

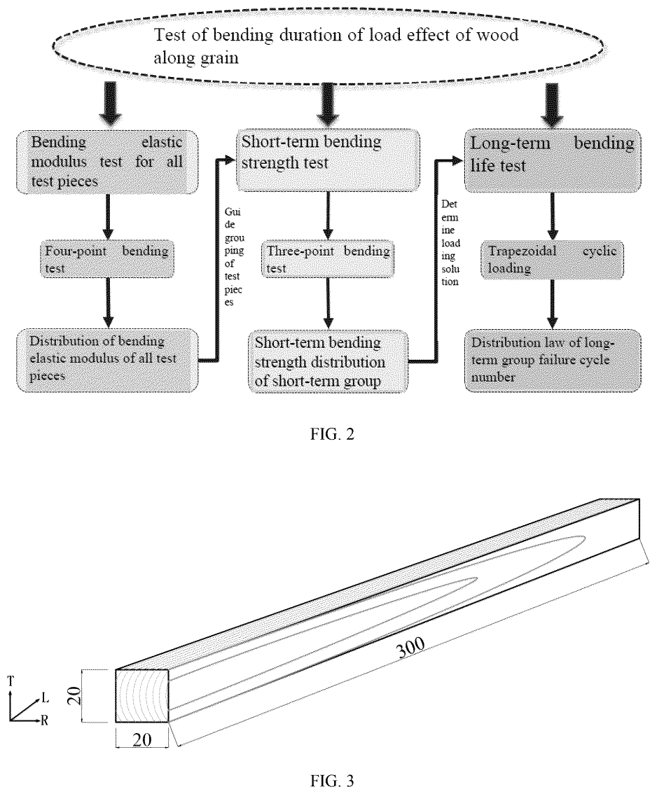

In some embodiments of the present disclosure, the test of bending duration of load effect of wood along the grain includes a bending elastic modulus test for all test pieces, a short-term bending strength test and a long-term bending life test, and logical relationship of the tests is shown in FIG. 2. The wood test pieces of three sub tests are sawn along the grain, all of which are 20×20×300 mm in size, and the test pieces do not contain natural defects such as pith, crack and knot scar. Meanwhile, when the test pieces are sawn, it is necessary to ensure that the chord direction and radial direction of the 20×20 mm cross-section texture of the test pieces are parallel to the edges of the test pieces as far as possible, as shown in FIG. 3. A specific implementation of the test of bending duration of load effect of wood along the grain is as follows:

a) The test of bending duration of load effect of wood along the grain shall be conducted with the bending elastic modulus test for all test pieces. The bending elastic modulus test is carried out by four-point bending chord-wise loading method, and displacement control loading is carried out at a rate of 2 mm/min. During a loading process, a relative longitudinal displacement at a midspan and a bearing of the test pieces is measured at the same time, to obtain a load-displacement curve. Corresponding data of 300N and 700N points are taken to calculate the bending elastic modulus, and take the average value after measuring each test piece for three times. According to the test results, the distribution of bending elastic modulus of all test pieces is obtained. According to the distribution results of bending elastic modulus, the test pieces are divided into two groups, one is a short-term bending strength degree test group, and the other is the long-term bending life test group (referred to as a short-term bending group and a long-term bending life test group for convenience of distinction).

b) After the bending elastic modulus test for all test pieces is completed, test spices of the short-term bending strength test group obtained by the above grouping are tested. The short-term bending strength test adopts a three-point bending chord-wise loading mode, and the displacement control load is carried out at a rate of 6 mm/min until the test pieces are destroyed. A load when the test pieces are destroyed is recorded as the maximum load, and the short-term bending strength of the test pieces is calculated. The test results (short-term bending strength) of the whole group are arranged in ascending order and the short-term bending strength distribution of the short-term bending group test groups is obtained.

c) After the short-term bending strength test is completed, the test pieces of the long-term bending life test group obtained by the above grouping are tested. A loading mode of the long-term bending test group is three-point bending chord-wise loading, and trapezoidal cyclic loading is carried out by a load control method. A trapezoidal cycle process includes three steps: loading, holding and unloading, each step is linear loading and lasts for a fixed time. A loading process of each cycle is exactly the same, and the cyclic loading is continued until the test pieces are destroyed, and the number of cycles carried out when the test pieces are destroyed is recorded, that is, the loading, holding and unloading times are t₁, t₂ and t₃ respectively, the loading and unloading process time are to be equal, that is, t₁=t₃, t₁ and t₃ are capable of being taken as 15 s-60 s, and the holding time t₂ is capable of being taken as 1-2 times t₁. After the test, the test results (cycles) of the whole group are arranged in ascending order, and a distribution law of failure cycles of long-term bending test pieces is obtained. The specific loading solution is shown in FIG. 4 (in which the peak stress corresponding to trapezoidal loading is capable of being taken as a certain quantile of the short-term bending strength distribution obtained above, and the minimum stress for unloading is capable of being taken as 10% of the peak stress).

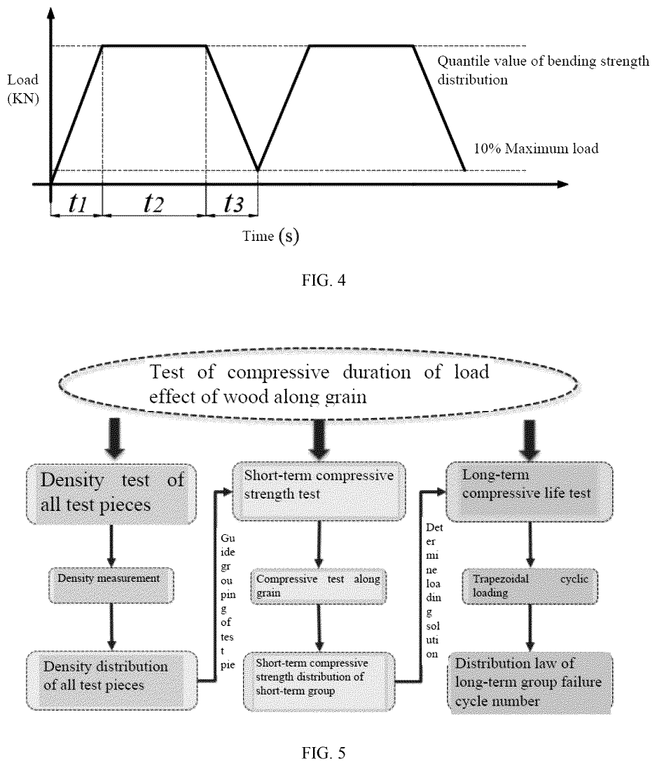

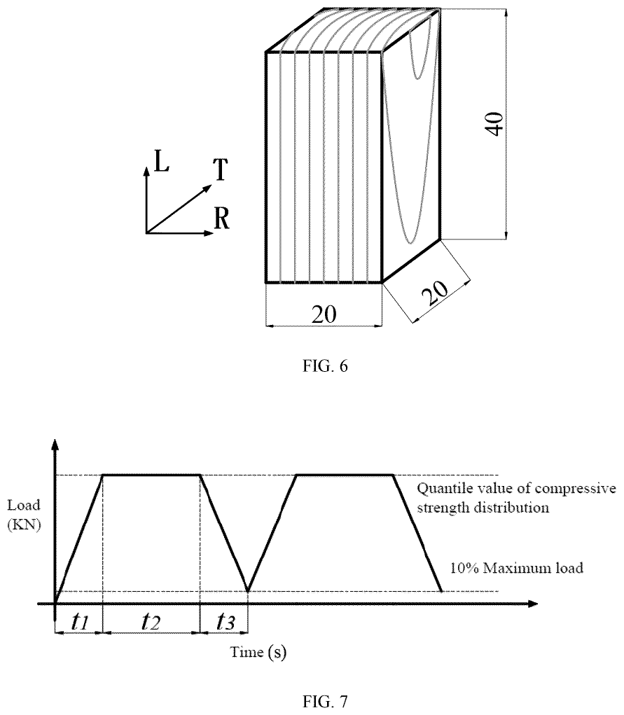

In some embodiments of the present disclosure, the test of compressive duration of load effect of wood along the grain includes: a density measurement test of all test pieces, a short-term compressive strength test and a long-term compressive life test, and the logical relationship is shown in FIG. 5. The size of wood test pieces in three sub tests is 20×20×40 mm, and the test pieces do not contain natural defects such as pith, crack and knot scar. Meanwhile, when the test pieces are sawn, it is necessary to ensure that the chord direction and radial direction of the 20×20 mm cross-section texture of the test pieces are parallel to the edge of the test pieces as far as possible, as shown in FIG. 6. A specific implementation of the test of compressive duration of load effect of wood along the grain is as follows.

a) For the test of compressive duration of load effect of wood along the grain, the density test of all test pieces is carried out first (it is enough to ensure the consistency of density measurement methods of all test pieces). According to the test results, the density distribution of all the test pieces is capable of being obtained, and the test pieces are divided into two groups according to the principle that the density distribution laws of the two groups are consistent, one group for the short-term compressive strength test, and the other group for the long-term compressive life test group (called a short-term compressive group and a long-term compressive group respectively for convenience of distinction).

b) After completing the density measurement test of all test pieces, the test pieces of the short-term compressive strength test group obtained are tested by the above grouping. The short-term compressive strength test adopts a longitudinal loading mode along the grain, and the displacement control loading is carried out at a rate of 1 mm/min until the test pieces are destroyed. The load when the test pieces are destroyed is recorded as the maximum load, and the short-term compressive strength of the test pieces is calculated. The test results (short-term compressive strength) are arranged in ascending order and short-term compressive strength distribution of short-term compressive group test pieces is obtained.

c) After the short-term compressive strength test is completed, the long-term compressive life test group test pieces obtained by the above grouping are tested, and the long-term compressive life test is longitudinal loaded along the grain direction of the test pieces, and the loading mode is load-controlled trapezoidal cyclic loading. A trapezoidal cycle process includes three steps: loading, holding and unloading, each step is linear loading and lasts for a fixed time. The loading process of each cycle is exactly the same, and the cyclic loading is continued until the test pieces are destroyed, and the number of cycles carried out when the test pieces are destroyed are recorded, that is, the loading, holding and unloading times are t₁, t₂ and t₃ respectively, the loading and unloading process time are to be equal, that is, t₁=t₃, t₁ and t₃ is capable of being taken as 15 s-60 s, and the holding time t₂ is capable of being taken as 1-2 times t1. After the test, the test results (cycles) of the whole group are arranged in ascending order, and the distribution law of failure cycles of long-term compressive group test pieces is obtained. The specific loading solution is shown in FIG. 7 (in which the peak stress corresponding to the trapezoidal loading can is capable of taken as a certain quantile of the short-term compressive strength distribution obtained above, and the minimum stress for unloading is capable of being taken as 10% of the peak stress).

In the above embodiment, the peak stress corresponding to trapezoidal loading in the long-term bending life test group is capable of being selected from the 5th-30th values of short-term bending strength distribution, and the peak stress corresponding to trapezoidal loading in the long-term compressive life test group is capable of being selected from the 5th-35th values of short-term compressive strength distribution. In the long-term life test group, the minimum stress of trapezoidal unloading is capable of being 10% of the peak stress of trapezoidal loading, to avoid the stress redistribution caused by unloading.

In one embodiment of the present disclosure, the total number of the test pieces for a test of bending/compression duration of load effect should be no less than 30, and the more the number of test specimens, the less the discreteness of the t results. When grouping in the test of bending/compression duration of load effect, ensure that the short-term test group and the long-term test group include the same number of specimens. During the test of bending/compression duration of load effect, water content of the test pieces is to be kept constant or slightly changed as far as possible. In some embodiments of the present disclosure, detecting deformation by strain gauge or other means may help to better determine failure time of the test pieces in the long-term bending/compressive life test.

In step 3, model parameters in a wood cumulative damage model are calibrated according to the results of a test of duration of load effect of wood. The short-term bending/compression strength distribution obtained by compression and bending respectively corresponds to the distribution law of long-term bending/compression failure cycles, and the results of the test of duration of load effect of wood are obtained by a method of equal-median matching, that is, the corresponding life of each bending/compression test piece in the test under its bending/compression load strength. The results of the test of bending duration of load effect of wood along the grain and the test of compressive duration of load effect of wood along the grain are brought into the wood cumulative damage model respectively, and updated wood cumulative damage model parameters suitable for the bending duration of load effect of wood along the grain and compressive duration of load effect of wood along the grain are calibrated by using the least square method of mathematical tools.

The above cumulative damage model of wood uses the concept of damage quantity to describe the damage of wood materials under any load history, which may be expressed by the following formula:

$$\frac{d α}{d t} = exp [ - a + b \frac{σ ( t )}{{σ}_{s}} ]$$

where, α is a damage state variable, where α=0, α=1 are a undamaged state and a failure state, respectively, and t represents untested test pieces. a and b are constants, σ(t) is history of applied stress, and σₛ is short-term strength of wood. Parameters a and b are parameters related to wood properties, which are calibration objects in the present disclosure.

In step 4, on the basis of updating the cumulative damage model of parameters, a residual strength prediction formula of the ancient wood is obtained by derivation and solution.

The residual strength prediction formula of the ancient wood may be expressed as:

$$\frac{σ}{{σ}_{s}} = \frac{1}{b} ln ( 1 + ( 1 - α ) ( exp b - 1 ) )$$

where, σ is the residual strength of wood, as is short-term strength of wood, and a represents a damage state variable, which may be calculated by integrating the above cumulative damage model of wood. The parameter b has the same meaning as in the above wood cumulative damage model, and is obtained after being calibrated by the method of the present disclosure.

Parts of the present disclosure that are not described in detail are known to those skilled in the art.

The embodiments of the present disclosure are described above with reference to the attached drawings, but the present disclosure is not limited to the above specific embodiments, which are only schematic, not restrictive. Under the inspiration of the present disclosure, ordinary technicians in the field may make many forms without departing from the object of the present disclosure and the scope protected by the claims, all of which are falling within the protection of the present disclosure.

1. A prediction method for residual strength of ancient wood applied in a shaking table test of a wood structure of an ancient building, comprising:
S1, determining a wood type and an origin predicted by residual strength of ancient wood according to a test target object;
S2, selecting new wood of the same type and origin to process test pieces according to determined wood type and origin;
S3, carrying out a test of duration of load effect of wood on processed test pieces, wherein the test of duration of load effect of wood comprises a test of bending duration of load effect of wood along the grain and a test of compressive duration of load effect of wood along the grain;
S4, calibrating model parameters in a wood cumulative damage model according to the results of a test of duration of load effect of wood; and
S5, obtaining a residual strength prediction formula of the ancient wood through derivation and solution, and predicting the residual strength of the ancient wood according to a wood cumulative damage model with calibrated parameters.

2. The prediction method for residual strength of ancient wood applied in a shaking table test of a wood structure of an ancient building according to claim 1, wherein the test of bending duration of load effect of wood along the grain comprises three sub-tests, namely, a bending elastic modulus test, a short-term bending strength test and a long-term bending life test.

3. The prediction method for residual strength of ancient wood applied in a shaking table test of a wood structure of an ancient building according to claim 1, wherein the test of compressive duration of load effect of wood along the grain comprises three sub-tests, namely, a test piece density measurement test, a short-term compressive strength test and a long-term compressive life test.

4. The prediction method for residual strength of ancient wood applied in a shaking table test of a wood structure of an ancient building according to claim 2, wherein there are not less than 30 test pieces in each sub-test to reduce the discreteness of data results.

5. The prediction method for residual strength of ancient wood applied in a shaking table test of a wood structure of an ancient building according to claim 3, wherein there are not less than 30 test pieces in each sub-test to reduce the discreteness of data results.

6. The prediction method for residual strength of ancient wood applied in a shaking table test of a wood structure of an ancient building according to claim 2, wherein the bending elastic modulus test is carried out by means of four-point bending chord-wise loading, and displacement control loading is carried out at a specific rate; during a loading process, relative longitudinal displacement at a midspan and bearing of the test pieces is measured to obtain a load-displacement curve, and the bending elastic modulus of the test pieces is calculated by taking data at specific points.

7. The prediction method for residual strength of ancient wood applied in a shaking table test of a wood structure of an ancient building according to claim 2, wherein the test pieces are divided into two groups according to the results of the bending elastic modulus test, and a principle of grouping is that distribution laws of two groups of elastic modulus are consistent; and in two groups of the test pieces, one for the short-term bending strength test and the other for the long-term bending life test.

8. The prediction method for residual strength of ancient wood applied in a shaking table test of a wood structure of an ancient building according to claim 6, wherein the short-term bending strength test adopts a three-point bending chord-wise loading mode, and the displacement control loading is carried out at a specific rate until the test pieces are destroyed, and short-term bending strength of the test pieces are calculated by taking a load when the test pieces are destroyed as the maximum load; and
in the long-term bending life test, the three-point bending chord-wise loading mode is adopted, and trapezoidal cyclic loading is carried out by a load control method until the test pieces are destroyed, and a number of cycles experienced when the test pieces are destroyed is recorded; and each trapezoidal cycle process comprises three processes: loading, holding and unloading, and each process is linear loading and lasts for a fixed time.

9. The prediction method for residual strength of ancient wood applied in a shaking table test of a wood structure of an ancient building according to claim 3, wherein a plurality of the test pieces are subjected to density measurement tests, and the test pieces are divided into two groups according to the results of the density measurement tests, with a principle that density distribution laws of the two groups are consistent; and among the two groups of the test pieces, one group is used as test pieces of the short-term compressive strength test and the other group as test pieces of the long-term compressive life test.

10. The prediction method for residual strength of ancient wood applied in a shaking table test of a wood structure of an ancient building according to claim 3, wherein the short-term compressive strength test adopts a longitudinal loading mode along the grain, and the displacement control loading is carried out at a specific rate until the test pieces are destroyed, and a load when the test pieces are destroyed is recorded as the maximum load, and the short-term compressive strength of the test pieces is calculated; and
in the long-term compressive life test, the trapezoidal cyclic loading is carried out along the grain direction of the test pieces by the load control method until the test pieces are destroyed, and the number of cycles carried out when the test pieces are destroyed is recorded; each trapezoidal cycle process comprises three processes: loading, holding and unloading, and each process is linear loading and lasts for a fixed time.

11. The prediction method for residual strength of ancient wood applied in a shaking table test of a wood structure of an ancient building according to claim 4, wherein the content of S4 comprises respectively corresponding distribution data of short-term bending/compressive strength obtained from the test of duration of load effect of wood with the distribution law of long-term bending/compressive failure cycles one by one, and obtaining the corresponding life of each test piece under the bending/compressive load strength it bears by means of equipartition value matching as the results of the test of duration of load effect of wood.

12. The prediction method for residual strength of ancient wood applied in a shaking table test of a wood structure of an ancient building according to claim 5, wherein the content of S4 comprises respectively corresponding distribution data of short-term bending/compressive strength obtained from the test of duration of load effect of wood with the distribution law of long-term bending/compressive failure cycles one by one, and obtaining the corresponding life of each test piece under the bending/compressive load strength it bears by means of equipartition value matching as the results of the test of duration of load effect of wood.
